(19) United States
(12) Patent Application Publication
(10) Pub. No.: US 2012/0140752 A1
(43) Pub. Date: Jun. 7, 2012

(54) VEHICLE MOBILE GATWAY FOR CONTROLLING CHARGING OF ELECTRIC VEHICLE USING MOBILE TERMINAL, ELECTRIC VEHICLE HAVING THE SAME, AND METHOD FOR CONTROLLING CHARGING OF ELECTRIC VEHICLE USING MOBILE TERMINAL

(75) Inventors: Hyun Jeong YUN, Daejeon-si (KR); So Yeon LEE, Daejeon-si (KR)

(73) Assignee: Electronics and Telecommunications Research Institute, Daejeon-si (KR)

(21) Appl. No.: 13/302,304

(22) Filed: Nov. 22, 2011

(30) Foreign Application Priority Data
Dec. 6, 2010 (KR) 10-2010-0123186

(51) Int. Cl. H04W 92/00

(52) U.S. Cl. 370/338

(57) ABSTRACT

Disclosed are a system and method allowing a user to control charging of an electric vehicle by using a mobile terminal in a remote area without the help of a charge station or a power management center. An electric vehicle controlled to be charged by using a mobile terminal includes: an electric vehicle main body; a battery unit installed in the electric vehicle main body and storing power upon receiving it from a charge station; and a vehicle mobile gateway installed in the electric vehicle main body and including a wireless communication unit performing radio communication with a mobile terminal and a battery unit controller electrically connected to the wireless communication unit to exchange data so as to allow the mobile terminal to control charging of the battery unit in a remote area and a calculation processing device to control the battery unit.

### CROSS-REFERENCE TO RELATED APPLICATIONS

This application claims the benefit of priority of Korean Patent application No. 10-2010-0123186 filed on Dec. 6, 2010, which is incorporated by reference herein.

### BACKGROUND OF THE INVENTION

1. Field of the Invention

The present invention relates to a vehicle mobile gateway for controlling charging of an electric vehicle by using a mobile terminal, an electric vehicle having the same, and a method for controlling charging of an electric vehicle by using a mobile terminal.

2. Description of the Related Art

Research into a wireless communication system allowing a mobile terminal and a vehicle to exchange information, more specifically, a system for controlling an electric vehicle by using a mobile terminal, is ongoing.

Recently, an electric vehicle sharing system is being pushed ahead in some countries, and in order to activate the sharing system, a system for collectively managing electrical vehicles as network objects based on a communication infrastructure is required. An electric vehicle controlling system using a mobile terminal can be applicable to the system.

Techniques required for establishing an electric vehicle network based on a smartphone includes a technique for exchanging information between a smartphone and a vehicle, a vehicle control technique, a wireless communication technique, or the like. Currently, the technique for exchanging information between a smartphone and an electric vehicle utilizes an intra-vehicle controller area network (CAN) communication technique, and communication between the smartphone and a service center utilizes a wireless mobile communication technique such as Wi-Fi, or the like.

In the related art, the mobile terminal is required to communicate with a charge station or a power management center in order to remotely control charging of the electric vehicle. Also, in order to receive a notification from the is charge station or the power management center in the occurrence of an unsolicited abnormal situation, user information must be previously registered to the charge station or the power management center.

### SUMMARY OF THE INVENTION

Therefore, an object of the present invention is to provide a system and method allowing a user to control charging of an electric vehicle by using a mobile terminal in a remote area without the help of a charge station or a power management center.

To achieve the above object, there is provided an electric vehicle controlled to be charged by using a mobile terminal, including: an electric vehicle main body; a battery unit installed in the electric vehicle main body and storing power upon receiving it from a charge station; and a vehicle mobile gateway installed in the electric vehicle main body and including a wireless communication unit performing radio communication with a mobile terminal and a battery unit controller electrically connected to the wireless communication unit to exchange data so as to allow the mobile terminal to control charging of the battery unit in a remote area and a calculation processing device to control the battery unit.

The battery unit may include: a battery; a charge connector having one side connected to the battery and the other side detachably attached to the charge station; a switching unit configured to electrically connect or disconnect the battery and the charge station each other; and a battery electronic control unit (ECU) configured to control the switching unit.

To achieve the above object, there is also provided a vehicle mobile gateway including: a main body; a wireless communication unit installed in the main body and performing radio communication with a mobile terminal; and a battery unit controller electrically connected to the wireless communication unit to exchange data so as to allow the mobile terminal to control charging of the battery unit in a remote area and a calculation processing device to control the battery unit.

To achieve the above object, there is also provided a method for controlling charging of an electric vehicle by using a mobile terminal, including: receiving, by a vehicle mobile gateway installed in an electric vehicle, an access permission request from a mobile terminal through radio communication; checking, by the vehicle mobile gateway, whether or not the mobile terminal has the authority for an access; when it is checked that the mobile terminal has the authority for an access, obtaining, by the vehicle mobile gateway, battery status information; and transmitting the obtained battery status information to the mobile terminal through radio communication.

The battery status information may include information regarding whether or not the electric vehicle is connected to a charge station supplying power or whether or not the electric vehicle is being currently charged.

The method may further include: periodically checking, by the vehicle mobile gateway, a change in the battery status information.

The periodically checking of a change in the battery status information may include: requesting, by the vehicle mobile gateway, current battery status information from a battery electronic control unit (ECU) of the electric vehicle; obtaining, by the battery ECU, the requested current battery status information; providing, by the battery ECU, the obtained current battery status information to the vehicle mobile gateway; and comparing, by the vehicle mobile gateway, the provided current battery status information and previously stored battery status information to check whether or not there has been a change in the current battery status information.

The method may further include: transmitting the change in the battery status information to the mobile terminal through radio communication.

The change in the battery status information may include: a case in which the electric vehicle connected to the charge station is separated from the charge station or a case in which the electric vehicle separated from the charge station is connected to the charge station.

The change in the battery status information may include a case in which charging, which has been performed, is stopped and a case in which charging, which has been stopped, is resumed.

The obtaining of the battery status information may include: receiving, by the vehicle mobile gateway, the request for the battery status information from the mobile terminal; checking the authority for an access with respect to the received request for the battery status information; and when it is checked that there is the authority for an access with respect to the request for the battery status information, obtaining the battery status information.

The battery status information may include an identifier list with respect to the battery status information which can be provided by the vehicle mobile gateway to the mobile terminal.

The obtaining of the battery status information may include: requesting, by the vehicle mobile gateway, a newly registered battery status information identifier from the battery ECU; providing, by the battery ECU, the newly registered battery status information identifier to the vehicle mobile gateway; and combining, by the vehicle mobile gateway, the received newly registered battery status information identifier with existing stored battery status information identifier to generate the battery status information identifier list which can be provided to the mobile terminal.

The method may further include: receiving, by the vehicle mobile gateway, a battery charge request from the mobile terminal confirmed to have the authority for an access; confirming, by the vehicle mobile gateway, the authority for an access with respect to the received battery charge request; and when the authority for an access with respect to the battery charge request is confirmed, charging, by the vehicle mobile gateway, the battery of the electric vehicle by the battery ECU of the electric vehicle.

The battery charge request may include information regarding at least one of an energy provider, a charge rate, and a battery voltage.

According to exemplary embodiments of the present invention, the user can monitor a charged state of an electric vehicle by using a mobile terminal in a remote area without the help of a charge station or a power management center and control charging of the electric vehicle.

Also, the user can check whether or not an unsolicited abnormal charged state has occurred by using the mobile terminal in a remote area without the help of a charge station or a power management center.

In addition, because a user authentication procedure is performed, only designated users can use an electric vehicle. The electric vehicle can be largely used for a lease service or in a public office. Thus, the user authentication procedure is required to allow only the designated users to use the electric vehicle.

Moreover, because the authority for an access by information unit of the user is checked, a firewall function can be performed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a system for controlling charging of an electric vehicle according to an exemplary embodiment of the present invention.

FIG. 2 is a schematic view of the system for controlling charging of an electric vehicle according to an exemplary embodiment of the present invention, in which an internal network of the electric vehicle is illustrated in detail.

FIG. 3 is a schematic block diagram of a vehicle mobile gateway according to an exemplary embodiment of the present invention.

FIG. 4 is a view illustrating the process of fabricating a configuration file for an access limitation with respect to each instance of vehicle status information.

FIG. 5 is a flow chart illustrating a system for controlling charging of an electric vehicle according to an exemplary embodiment of the present invention, which specifically shows the process of informing a mobile terminal about an unexpected start and end of charging and the occurrence of an abnormal situation.

FIG. 6 is a flow chart illustrating a method for controlling charging of an electric vehicle according to an exemplary embodiment of the present invention, which specifically shows how to cope with an abnormal charging situation.

FIG. 7 is a schematic view illustrating the method for controlling charging of an electric vehicle according to an exemplary embodiment of the present invention, which specifically shows the process in which the mobile terminal is requests a list of data IDs which can be checked from a vehicle mobile gateway (VMG) and receives a response.

FIG. 8 is a flow chart illustrating the method for controlling charging of an electric vehicle according to an exemplary embodiment of the present invention, which specifically shows a charge reservation process in which a user searches for a charging table to select a desired charge time slot and an energy provider.

FIG. 9 is a flow chart illustrating the process of a method for controlling charging of an electric vehicle according to a first exemplary embodiment of the present invention.

FIG. 10 is a flow chart illustrating the process of a method for controlling charging of an electric vehicle according to a second exemplary embodiment of the present invention.

FIG. 11 is a flow chart illustrating the process of a method for controlling charging of an electric vehicle according to a third exemplary embodiment of the present invention.

### DETAILED DESCRIPTION OF THE INVENTION

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

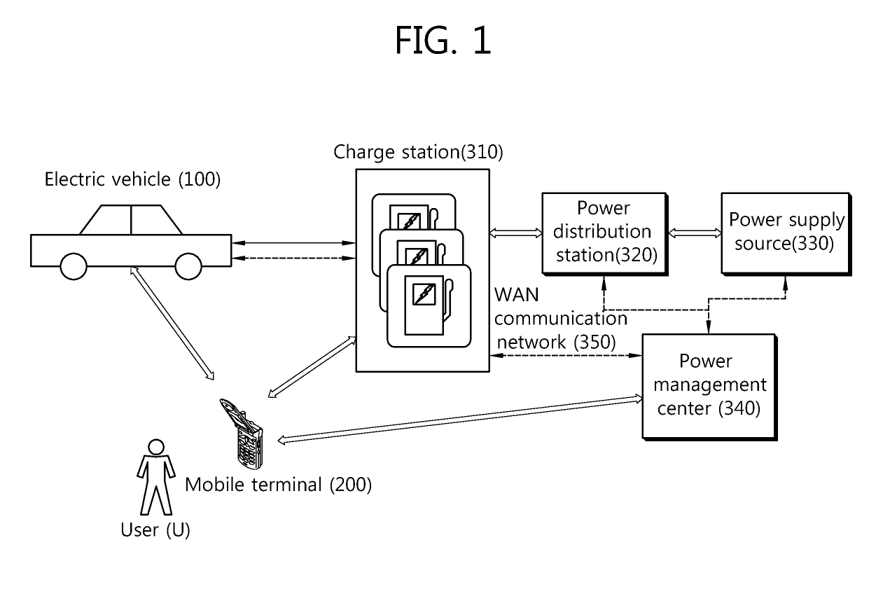

FIG. 1 is a schematic view of a system for controlling charging of an electric vehicle according to an exemplary embodiment of the present invention.

As shown in FIG. 1, the system for controlling charging (or charging control system) of an electric vehicle may include a mobile terminal 200 of a user (U), an electric vehicle 100 of the user (U), a charge station 310, a power management center 340, a power distribution station 320, and a power supply source 330. The electric vehicle 100, a means for transportation using electricity as power, may be a passenger car, a bus, a motor cycle, or the like.

The power supply source 330 supplies power to the power distribution station 320, and the power distribution station 320 distributes power supplied from the power supply source 330 to a plurality of charge stations 310. In a different exemplary embodiment, the power supply source 330 may directly supply power to the charge stations.

In order to control the amount of power supplied to the charge station 310, the power management center 340 may exchange information with the power supply source 330, the power distribution station 320, and the charge station 310 through a WAN communication network 350.

The electric vehicle 100 may exchange charge information with the charge station 310 by using an ISO 11185 standard interface therebetween in order to receive power from the charge station 310. The charge information may be exchanged between the electric vehicle 100 and the charge station 310 according to a power line communication (PLC) scheme or a controller area network (CAN) scheme.

When an authentication for power supply is secured by the electric vehicle 100 through the exchange of charge information, a battery of the electric vehicle 100 can be charged.

The mobile terminal 200 may wirelessly exchange information with the electric vehicle 100, the charge station 310, and the power management center 340. The mobile terminal 200 may be a PDA, a mobile phone, a smartphone, or the like.

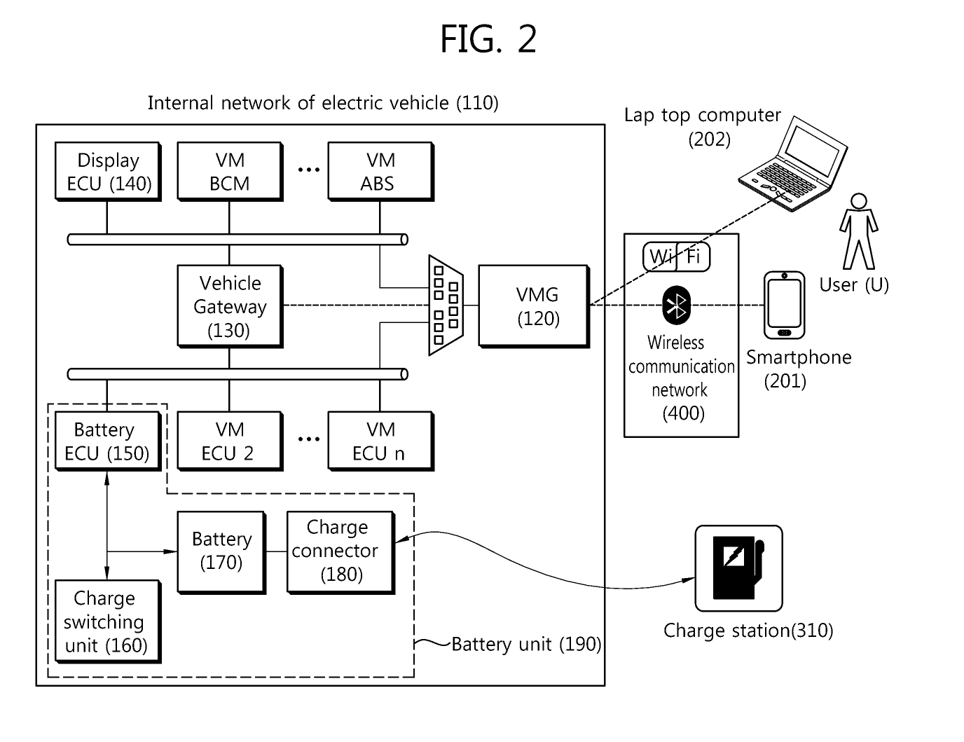

FIG. 2 is a schematic view of the system for controlling charging of an electric vehicle according to an exemplary embodiment of the present invention, in which an internal network of the electric vehicle is illustrated in detail.

As shown in FIG. 2, the electric vehicle 100 includes a plurality of electronic control units (ECUs), a body control module (BCM), a vehicle gateway (VG) 130, a vehicle mobile gateway (VMG) (or a vehicle ITS-S gateway) 120.

The ECUs are electronic devices for controlling a battery, an engine, an automatic transmission, an ABS, or the like. The BCM is a module for controlling a window or a door or integratedly or collectively controlling the ECUs. The BCM, the ECUs, the VG, and the VMG may be nodes of a network using a protocol such as the CAN, a local interconnect network (LIN), or the like. Information between the nodes of the internal network including the BCM, the ECUs, or the like, may be exchanged through the VG 130. Information exchange between the internal network 110 of the electric vehicle and an external terminal such as the smartphone 201, a lap-top computer 202, or the like, through a wireless communication network 400 is performed through the VMG 120.

As the scheme of wireless communication, e.g., Wi-Fi, Bluetooth™, or the like, may be used. The VMG 120 may be implemented as hardware connected to a node of the internal network 110 of the electric vehicle 100 or an OBD system. Also, the VMG 120 may be implemented as a software module coupled to a display ECU or a head-up display (HUD).

A battery unit 190 of the electric vehicle 100 includes a battery 170, a charge connector 180 connecting the charge station 310 and the battery 170, a charge switching unit 160, and a battery ECU 150. The battery ECU 150 may monitor the status of the battery 170 and control starting and ending of battery charging through the charge switching unit 160. Also, the battery ECU 150 may monitor a maximum voltage, a minimum voltage, a connection status of the charge connector 180.

The display ECU 140 and the battery ECU 150 is able to exchange information through the VG 130, so the user (U) can check the status of the battery 170 by using the display ECU 140.

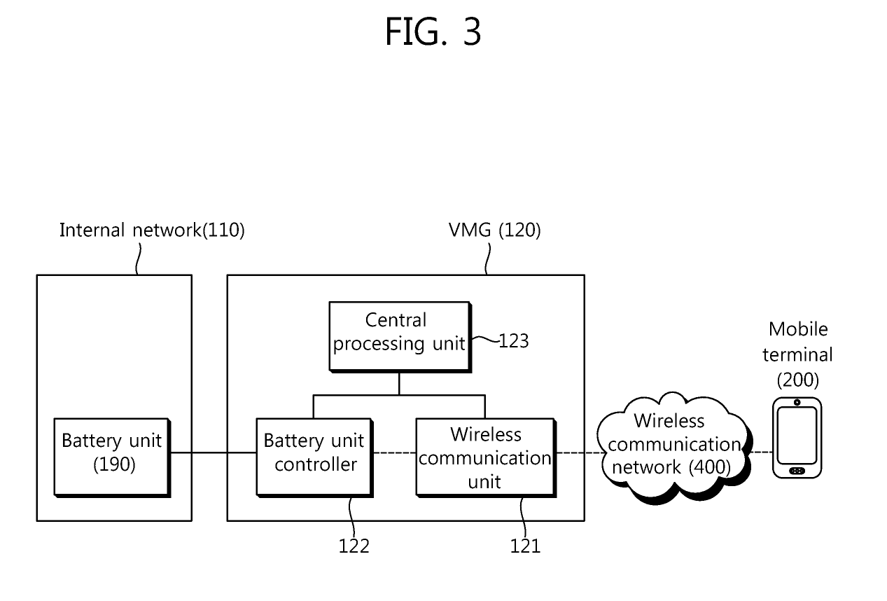

FIG. 3 is a schematic block diagram of a vehicle mobile gateway according to an exemplary embodiment of the present invention.

As shown in FIG. 3, the VMG (or vehicle ITS-S gateway) 120 includes a wireless communication unit 121, a battery unit controller 122, and a central processing unit 123.

The wireless communication unit 121 performs radio communication with the mobile terminal 200 through the wireless communication network 400. The battery unit controller 122 is electrically connected to the wireless communication unit 121 to exchange data to allow the mobile terminal 200 to control charging of the battery unit 190 of the internal network 110 of the electric vehicle in a remote area, and is configured to include a calculation processing device to control the battery unit 190. The central processing unit 123 integratedly controls the wireless communication unit 121, the battery unit controller 122, and the like.

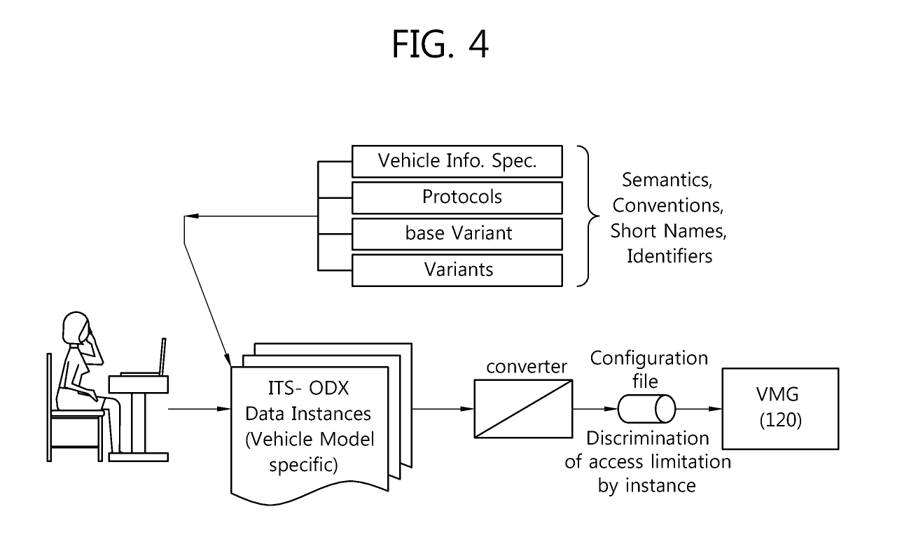

FIG. 4 is a view illustrating the process of fabricating a configuration file for an access limitation with respect to each instance of vehicle status information.

In order for the VMG 120 and the external terminal to exchange information, basic information such as a network ID, a message ID, a vehicle VIN, a vehicle model, or the like, is required. The basic information may include user information. The basic information may be used to authenticate a user or to perform a firewall function. A configuration file including the basic information may be downloaded to the electric vehicle by a VMG manufacturer or manager before operating the vehicle.

A vehicle information identifier is used to exchange information between the VMG 120 and the external terminal. The vehicle information identifier includes an ECU ID and a data ID.

As shown in Table 1 below, for example, the instance ‘ECU-4:Data ID-4’ is a vehicle information identifier with respect to the status of the electric vehicle and performs a function of monitoring the status of the electric vehicle.

The value of ‘ECU-4:Data ID-4’ can indicate information regarding whether or not a connector is connected, and the authority to access the information is set to an operator. Thus, if someone else, not the operator, accesses the VMG 120, he cannot monitor electric vehicle status information. The authority to access each instance can be managed by the VMG 120.

TABLE 1
<Examples of granting the authority to access each data instance>

| Vehicle | | | | |
|---|---|---|---|---|
| information | Vehicle | | | Access |
| identifier | information | Function | Value (unit) | authority |
| ECU-1: Data | Door of the | Lock/Unlock/ | Lock/Unlock | Operator/ |
| ID-1 | operator side | Monitor | | passenger/ |
| | | | | mechanic |
| ECU-1: Data | Safety belt | | Engaged/Not | Operator/ |
| ID-2 | | | Engaged | passenger |
| ECU-1: Data | Window | Lock/Unlock/ | Lock/Unlock | Operator/ |
| ID-3 | | Monitor | | passenger/ |
| | | | | mechanic |
| ECU-4: Data | EV status | Monitor | Charge (Yes or | Operator |
| ID-4 | | | No)/connection | |
| | | | of connector | |
| | | | (lock or | |
| | | | unlock) | |
| ECU-4; Data | Charge rate | Monitor | Charge rate(%) | Operator/ |
| ID-5 | | | | passenger |

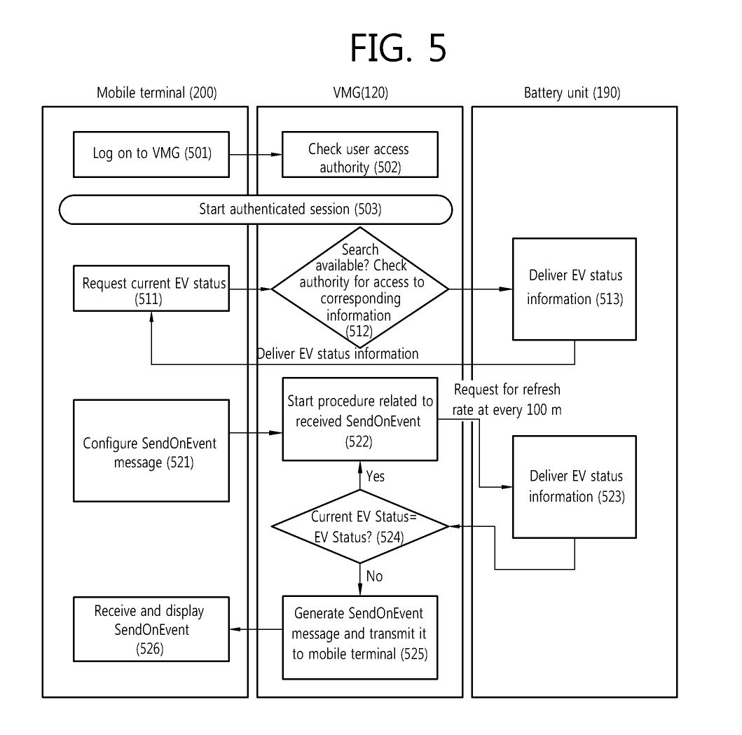

FIG. 5 is a flow chart illustrating a system for controlling charging of an electric vehicle according to an exemplary embodiment of the present invention, which specifically shows the process of informing a mobile terminal about an unexpected start and end of charging and the occurrence of an abnormal situation.

First, the mobile terminal 200 logs on to the VMG 120 of the electric vehicle in step 501, and the user's authority for an access is checked in step 502. Accordingly, an authenticated session starts. The mobile terminal 200 may request current electric vehicle status information from the VMG 120 in step 511. The authority for accessing the current electric vehicle status information may be checked by the VMG 120 in step 512. In addition, the information regarding a current status of the electric vehicle may be delivered in step 513. The information regarding the current status of the electric vehicle is used to configure a SendOnEvent message of the VMG 120.

The mobile terminal may configure the SendOnEvent message and transmit the same to the VMG 120 in step 521. The SendOnEvent message may include the ID of the battery ECU, the data ID with respect to the status information of the electric vehicle, a refresh rate (e.g., 100 ms) as an event occurrence check period, and already obtained electric vehicle status information.

Subsequently, the VMG 120 may start the procedure related to the received SendOnEvent message in step 522. The battery ECU 150 may deliver the electric vehicle status information in step 523. The VMG 120 may obtain a value corresponding to the ID of the battery ECU and a value corresponding to the data ID with respect to the electric vehicle (EV) status information at every refresh rate (100 ms) and compare the with the already obtained electric vehicle (EV) status information in step 524.

When the EV status has been changed, the VMG 120 may generate a SendOnEvent message and transmit the same to the mobile terminal 200 in step 525. In this case, the SendOnEvent message may include the information regarding the electric vehicle status and GPS information. Subsequently, the information regarding the change in the electric vehicle status is displayed on the mobile terminal 200 in step 526.

The user can recognize whether or not an abnormal charge condition has occurred through the information regarding the electric vehicle status. Namely, whether or not the charge connector 180 has been coupled to the charge station 310 without the knowledge of the user or whether or not the charge connector 180 and the charge station 310 has been separated during a charging operation can be checked by the user in a remote area.

In order to transmit information regarding the separation between the charge connector 180 and the charge station 310 during a charging operation by the charge station 310 or the power management center 340 to the user's mobile terminal 200, user information must be necessarily provided in advance to the charge station 310 or the power management center 340. However, according to an exemplary embodiment of the present invention, the user can check the occurrence of an unsolicited abnormal charge condition by using the mobile terminal in a remote area without the help of the charge station 310 or the power management center 340.

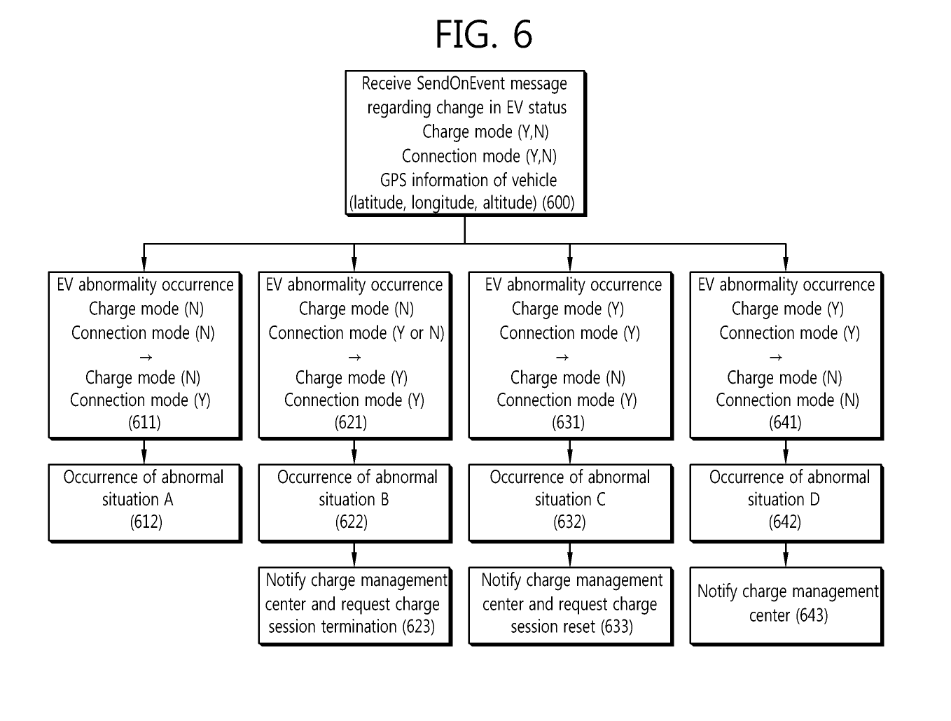

FIG. 6 is a flow chart illustrating a method for controlling charging of an electric vehicle according to an exemplary embodiment of the present invention, which specifically shows how to cope with an abnormal charging situation.

As shown in FIG. 6, the mobile terminal 200 receives the generated SendOnEvent message in step 600. The SendOnEvent message may include a charge mode (Y: on charge, N: not charged), a connection mode (Y: connector connected, N: connector not connected), and GPS information.

When the charge mode is ‘N’ and the connection mode is ‘N’ in the already obtained current electric vehicle status information and the charge mode is ‘N’ and the connection mode is ‘Y’ in the newly obtained current electric vehicle status information, it may be determined that an abnormal charge condition A has occurred in steps 611 and 612. The abnormal charge condition A refers to a situation in which someone else has connected the connector 180 and the charge station 310 against a user's intention. For example, a person has connected the charge connector 180 and the charge station 310 for a lark. In addition, the information indicating that the abnormal charge condition A has occurred may be provided to the user.

When the charge mode is ‘N’ and the connection mode is ‘N’ or ‘Y’ in the already obtained current electric vehicle status information and the charge mode is ‘Y’ and the connection mode is ‘Y’ in the newly obtained current electric vehicle status information, it may be determined that an abnormal charge condition B has occurred in steps 621 and 622. The abnormal charge condition B refers to a situation in which the charge station 310 and the charge connector 180 are connected but charging has started against a user's intention. For example, the user does not want to perform charging, but charging has started due to machine malfunction. The user may transmit information indicating that the abnormal charge condition B has occurred to the mobile terminal, or to the charge station 310 or the power management center 340 in order to request a charge session termination in step 623.

When the charge mode is ‘Y’ and the connection mode is ‘Y’ in the already obtained current electric vehicle status information and the charge mode is ‘N’ and the connection mode is ‘Y’ in the newly obtained current electric vehicle status information, it may be determined that an abnormal charge condition C has occurred in steps 631 and 632. The abnormal charge condition C refers to a situation in which the charge station 310 and the charge connector 180 are connected but charging has been stopped against a user's intention. In this case, it does not mean a situation in which a pre-set charge amount has reached a charge termination is required or a situation in which the user requests a charge termination purposefully. Namely, the abnormal charge condition C may be a situation in which charging has been stopped due to malfunction of a charge session. The user may transmit information indicating that the abnormal charge condition C has occurred to the mobile terminal, or to the charge station 310 or the power management center 340 in order to request resetting of a charge session in step 633.

When the charge mode is ‘Y’ and the connection mode is ‘Y’ in the already obtained current electric vehicle status information and the charge mode is ‘N’ and the connection mode is ‘N’ in the newly obtained current electric vehicle status information, it may be determined that an abnormal charge condition D has occurred in steps 641 and 642. The abnormal charge condition D refers to a situation in which the charge station 310 and the charge connector 180 are separated against a user's intention. For example, in a status in which the user starts charging and then steps away, someone may separate the charge station 310 and the charge connector 180 for a lark. The user may transmit information indicating that the abnormal charge condition D has occurred to the mobile terminal, or to the charge station 310 or the power management center 340 in order to ask for a help in step 643.

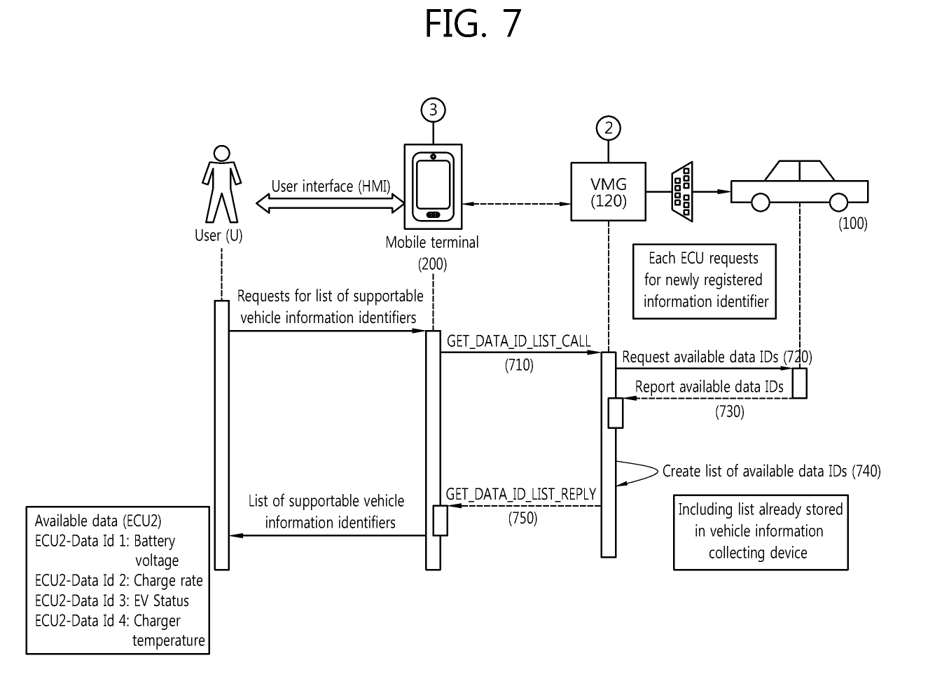

FIG. 7 is a schematic view illustrating the method for controlling charging of an electric vehicle according to an exemplary embodiment of the present invention, which specifically shows the process in which the mobile terminal requests a list of data IDs which can be checked from a vehicle mobile gateway (VMG) and receives a response.

First, the mobile terminal 200 requests a list of data IDs which can be checked, from the VMG 120 in step 710 (GET_DATA_ID_LIST_CALL). Upon receiving the request, the VMG 120 may request newly registered data ID(s) and/or existing data IDs which can be checked, from the respective ECUs in step 720. Upon receiving the request, each of the ECUs may transmit data IDs which can be checked to the VMG 120 in step 730. Subsequently, the VMG 120 may generate a list of the data IDs which can be checked, and makes a response to the mobile terminal 200 in steps 740 and 750 (GET_DATA_ID_LIST_REPLY). In a different exemplary embodiment, when the mobile terminal 200 requests the list of the data IDs which can be checked, from the VMG 120, the list of data IDs which are stored and can be checked (i.e., the list which has been automatically updated periodically) may be transmitted to the mobile terminal 200.

The list of data IDs which can be checked may include information regarding a battery voltage, a charge rate, an electric vehicle status (the charge mode and the connection mode), the temperature of a recharger, and the like. The list of data IDs which can be checked is displayed on the mobile terminal 200 so that the user can recognize the data.

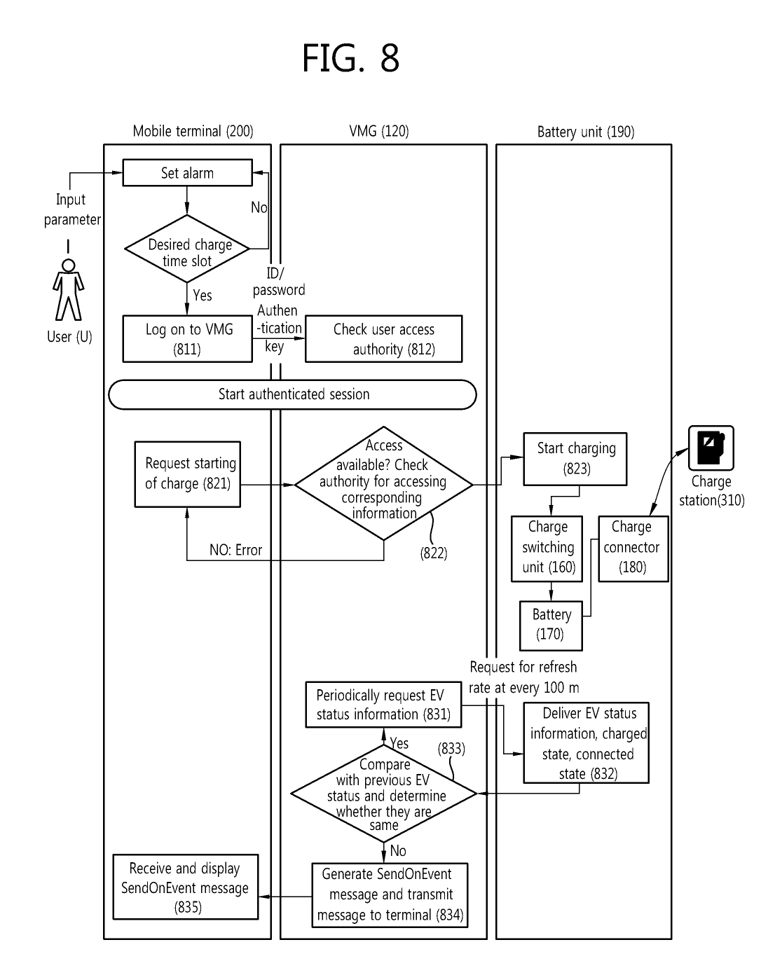

FIG. 8 is a flow chart illustrating the method for controlling charging of an electric vehicle according to an exemplary embodiment of the present invention, which specifically shows a charge reservation process in which a user searches for a charging table to select a desired charge time slot and an energy provider.

As shown in FIG. 8, the user (U) requests starting of charging through the mobile terminal. In this case, the charge start request may include an input parameter. The input parameter may include a charge time slot, the amount desired to be charged (charge rate: %), an energy provider, or the like. Since an energy provider can be selected, the user can select power supplied by a particular energy providing company and also select the type of particular energy (e.g., energy by waterpower generation, energy by wind power, energy using fossil fuel, etc.).

Next, when a pre-set charge time arrives, the user logs on to the VMG 120 in step 811. Subsequently, the user's authority for an access is checked in step 812. Accordingly, an authenticated session starts.

Thereafter, the charge start request is transmitted to the VMG 120 in step 821, and the authority to access the relevant information is checked by the VMG 120 in step 822. In a different exemplary embodiment, the authority to access the relevant information may be checked by the battery ECU 150 or any other ECU.

When the authority for an access is confirmed, a battery charge request is transmitted to the battery ECU 150, and charging may start by the battery unit 190 in step 823. Accordingly, the battery unit 190 controls the charge switching unit 160 to charge power, which is supplied from the charge station 310, to the battery 170 through the charge connector 180.

The VMG 120 may periodically request electric vehicle status information from the battery ECU 150 according to the refresh rate of the SendOnEvent message in step 831. Accordingly, the battery unit 190 may transmit the electric vehicle status information to the VMG 120 in step 832. In a different exemplary embodiment, the battery ECU 150 may periodically transmit the electric vehicle status information to the VMG 120 according to a previously stored refresh rate without a request from the VMG 120. The electric vehicle status information includes information regarding the charge mode and the connection mode. The VMG 120 compares the received electric vehicle status information and previously stored electric vehicle status information, and when there is a change in the received electric vehicle status information, the VMG 120 generates the SendOnEvent message and transmits it to the mobile terminal 200 in steps 833 and 834. The mobile terminal may be set such that an alarm is operated when charging is completed.

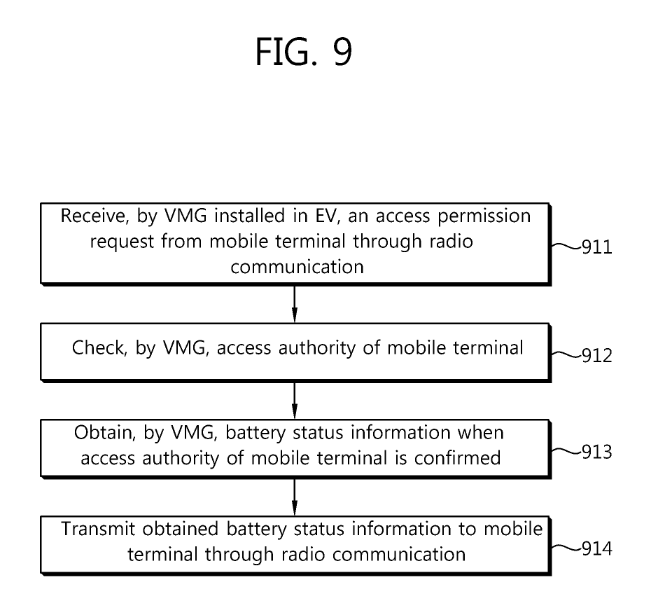

FIG. 9 is a flow chart illustrating the process of a method for controlling charging of an electric vehicle according to a first exemplary embodiment of the present invention.

As shown in FIG. 9, first, the VMG installed in the electric vehicle may receive an access permission request from the mobile terminal through radio communication in step 911. Next, the VMG may check whether or not the mobile terminal has the authority for an access in step 912. When it is determined that the mobile terminal has the authority for an access, the VMG obtains battery status information in step 913. The VMG may transmit the obtained battery status information to the mobile terminal through radio communication in step 914.

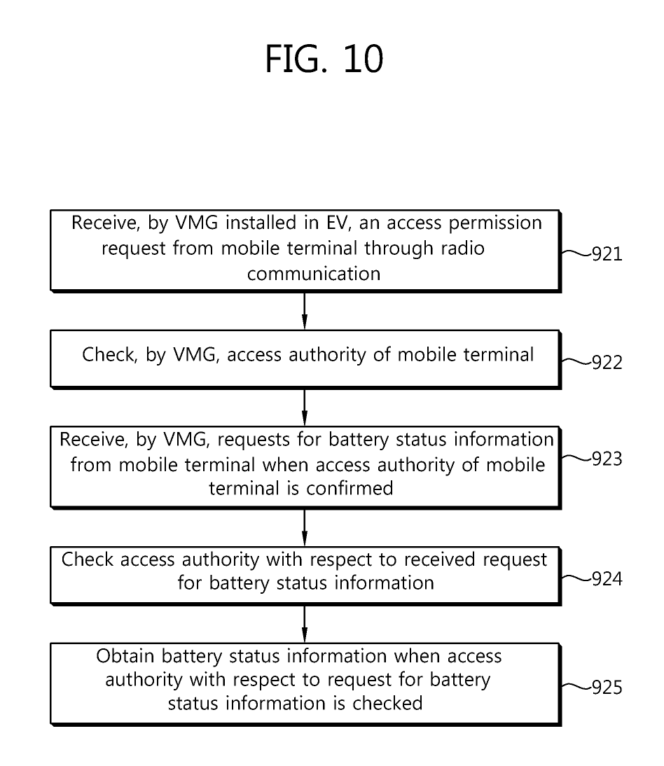

FIG. 10 is a flow chart illustrating the process of a method for controlling charging of an electric vehicle according to a second exemplary embodiment of the present invention.

As shown in FIG. 10, first, the VMG installed in the electric vehicle may receive an access permission request from the mobile terminal through radio communication in step 921. Next, the VMG may check whether or not the mobile terminal has the authority for an access in step 922. When it is determined that the mobile terminal has the authority for an access, the VMG receives a battery status information request from the mobile terminal in step 923. It is checked whether or not the mobile terminal has the authority for an access with respect to the received battery status information request in step 924. When it is determined that the mobile terminal has the authority for an access with respect to the battery status information request, the VMG obtains battery status information in step 925.

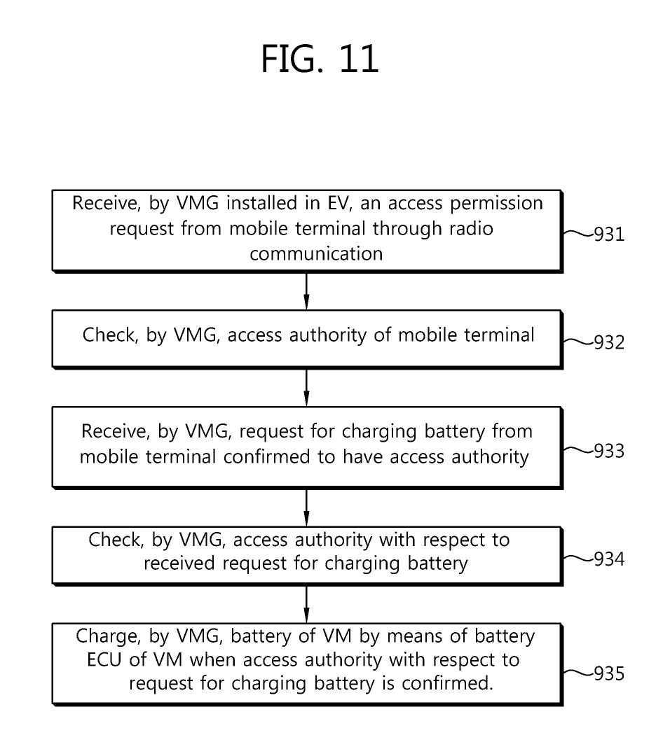

FIG. 11 is a flow chart illustrating the process of a method for controlling charging of an electric vehicle according to a third exemplary embodiment of the present invention.

As shown in FIG. 11, first, the VMG installed in the electric vehicle may receive an access permission request from the mobile terminal through radio communication in step 931. Next, the VMG may check whether or not the mobile terminal has the authority for an access in step 932. When it is determined that the mobile terminal has the authority for an access, the VMG may receive a battery charge request from the mobile terminal determined to have the authority for an access in step 933. The VMG checks whether or not the mobile terminal has the authority for an access with respect to the received battery charge request in step 934. When it is determined that the mobile terminal has the authority for an access with respect to the received battery charge request, the VMG may allow the battery ECU of the electric vehicle to charge the battery of the electric vehicle in step 935.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electric vehicle controlled to be charged by using a mobile terminal, the electric vehicle comprising:
an electric vehicle main body;
a battery unit installed in the electric vehicle main body and storing power upon receiving it from a charge station; and
a vehicle mobile gateway installed in the electric vehicle main body, the vehicle mobile gateway comprising
a wireless communication unit performing radio communication with a mobile terminal; and
a battery unit controller which is electrically connected to the wireless communication unit to exchange data so as to allow the mobile terminal to control charging of the battery unit in a remote area and has a is calculation processing device to control the battery unit.

2. The electric vehicle of claim 1, wherein the battery unit comprises:
a battery;
a charge connector having one side connected to the battery and the other side detachably attached to the charge station;
a switching unit configured to electrically connect or disconnect the battery and the charge station each other; and
a battery electronic control unit (ECU) configured to control the switching unit.

3. A vehicle mobile gateway comprising:
a main body;
a wireless communication unit installed in the main body and performing radio communication with a mobile terminal; and
a battery unit controller which is electrically connected to the wireless communication unit to exchange data so as to allow the mobile terminal to control charging of the battery unit in a remote area and has a calculation processing device to control the battery unit.

4. A method for controlling charging of an electric vehicle by using a mobile terminal, the method comprising:
receiving, by a vehicle mobile gateway installed in an electric vehicle, an access permission request from a mobile terminal through radio communication;
checking, by the vehicle mobile gateway, whether or not the mobile terminal has authority for an access;
when the mobile terminal's authority for an access is checked, obtaining, by the vehicle mobile gateway, battery status information; and
transmitting, by the vehicle mobile gateway, the obtained battery status information to the mobile terminal through radio communication.

5. The method of claim 4, wherein the battery status information comprises information regarding whether or not the electric vehicle is connected to a charge station supplying power or whether or not the electric vehicle is being currently charged.

6. The method of claim 5, further comprising:
periodically checking, by the vehicle mobile gateway, a change in the battery status information.

7. The method of claim 6, wherein the periodically checking of a change in the battery status information comprises:
requesting, by the vehicle mobile gateway, current battery status information from a battery electronic control unit (ECU) of the electric vehicle;
obtaining, by the battery ECU, the requested current battery status information;
providing, by the battery ECU, the obtained current battery status information to the vehicle mobile gateway; and
comparing, by the vehicle mobile gateway, the provided current battery status information and previously stored battery status information to check whether or not there has been a change in the current battery status information.

8. The method of claim 6, further comprising:
transmitting, by the vehicle mobile gateway, the change in the battery status information to the mobile terminal through radio communication.

9. The method of claim 8, wherein the change in the battery status information comprises a case in which the electric vehicle connected to the charge station is separated from the charge station or a case in which the electric vehicle separated from the charge station is connected to the charge station.

10. The method of claim 8, wherein the change in the battery status information comprises a case in which charging, which has been performed, is stopped and a case in which charging, which has been stopped, is resumed.

11. The method of claim 4, wherein the obtaining of the battery status information comprises:
receiving, by the vehicle mobile gateway, the request for the battery status information from the mobile terminal;
checking the authority for an access with respect to the received request for the battery status information; and
when the authority for an access with respect to the request for the battery status information, obtaining, by the vehicle mobile gateway, the battery status information.

12. The method of claim 11, wherein the battery status information comprises an identifier list with respect to the battery status information which can be provided by the vehicle mobile gateway to the mobile terminal.

13. The method of claim 12, wherein the obtaining of the battery status information comprises:
requesting, by the vehicle mobile gateway, a newly registered battery status information identifier from the battery ECU;
providing, by the battery ECU, the newly registered battery status information identifier to the vehicle mobile gateway; and
combining, by the vehicle mobile gateway, the received newly registered battery status information identifier with existing stored battery status information identifier to generate the battery status information identifier list which can be provided to the mobile terminal.

14. The method of claim 4, further comprising:
receiving, by the vehicle mobile gateway, a battery charge request from the mobile terminal confirmed to have the authority for an access;
confirming, by the vehicle mobile gateway, the authority for an access with respect to the received battery charge request; and
when the authority for an access with respect to the battery charge request is confirmed, charging, by the vehicle mobile gateway, the battery of the electric vehicle by the battery ECU of the electric vehicle.

15. The method of claim 14, wherein the battery charge request comprises is information regarding at least one of an energy provider, a charge rate, and a battery voltage.
